(19) United States
(12) Patent Application Publication
(10) Pub. No.: US 2007/0089610 A1
(43) Pub. Date: Apr. 26, 2007

(54) Wet-type electric cleaning apparatus

(75) Inventor: Akimitsu Hayashi, Matsumoto (JP)

Correspondence Address: KODA & ANDROLIA, 2029 CENTURY PARK EAST, SUITE 1140, LOS ANGELES, CA, 90067, US

(73) Assignee: IZUMI PRODUCTS COMPANY

(21) Appl. No.: 11/584,836

(22) Filed: Oct. 23, 2006

(30) Foreign Application Priority Data
Oct. 24, 2005 (JP) 2005-307984

(51) Int. Cl. B01D 47/00; B01D 53/14

(52) U.S. Cl. 96/317; 96/262

(57) ABSTRACT

A wet-type electric cleaning apparatus for inducting outside air, which contains dust, into a liquid stored in a liquid tank 10 by reducing the pressure inside the upper space 42 inside the liquid tank 10. The cleaning apparatus includes an intake passage 32 having a discharge port 26 for discharging the dust-contained outside air as a swirling flow, from the central bottom inside the liquid tank 10, a disc-shape guide panel 34 provided above the discharge port 26 with its radius gradually decreasing from the vicinity of the center of the liquid tank 10, forming a ring-shaped gap 36 between itself and the inner surface of the liquid tank 10 to allow air to pass through the ring-shaped gap 36 into the upper space 42 in a form of a swirling flow, and an exhaust passage for exhausting air from the upper space 42 of the liquid tank 10.

### BACKGROUND OF THE INVENTION

1. Field of the Invention

The present invention relates to a wet-type electric cleaning apparatus for removing dust by passing outside air that contains dust through a liquid stored inside the liquid tank.

2. Description of the Related Art

In a wet-type electric cleaning apparatus, water is placed in the liquid tank, and outside air that contains dust is vigorously mixed with that water, causing the dust to be captured in the water. For that reason, a large amount of water droplets will be contained in the air exhausted from the liquid tank (water tank).

The pressure inside the upper space in the liquid tank is reduced by an exhaust pump; however, when the amount of water droplets contained in the air in that upper space becomes large, water tends to be taken into the exhaust pump, so that the exhaust pump will be damaged, and moisture will be contained in the exhaust air that is exhausted from the exhaust pump to the outside, which is undesirable.

Japanese Utility Model Application Publication (Kokoku) No. 63-12839 discloses an apparatus in which a substantially cup-shaped moisture separator (turning separator) that turns at high speed is provided in the upper space inside a water tank, and the air inside the water tank (air containing water droplets) is conducted through a slit provided in the moisture separator to the inside thereof and conducted to an exhaust pump. With that slit, the water droplets are separated by centrifugal force and returned to the water tank.

Japanese Patent Application Publication (Kokoku) No. 6-104098 and Japanese Patent Application Laid-Open (Kokai) No. 4-92636 disclose apparatuses in which outside air that contains dust is directed toward and made to flow into the upper space inside a cylindrical water tank, and the dust is captured in the water by causing the dust to vigorously contact the water surface. In these apparatuses, air is discharged from the center of the upper space of the water tank.

In the apparatuses disclosed in Japanese Patent Nos. 2701132 (Japanese Patent Application Laid-Open (Kokai) No. 7-289485), 2701129 (Japanese Patent Application Laid-Open (Kokai) No. 7-275168), and 2772754 (Japanese Patent Application Laid-Open (Kokai) 7-163497), outside air that contains dust is made to flow into water from the inner circumference surface inside the water tank toward the swirling direction. Japanese Patent No. 2701132 and 2701129 disclose cylinders of differing radius that are combined from above and below to form a maze (bending air passage), so that water is separated.

In all of the apparatuses of the above-described related art, outside air that contains dust is caused to flow in along the inner circumference surface of the water tank, and air is discharged from the center of the water tank. In contrast thereto, in the apparatuses shown in Japanese Utility Model Application Publication (Kokoku). No. S53-23982 and Japanese Patent Application Laid-Open (Kokai) No. H10-128033, outside air is conducted into water from an outer cylinder which is advanced in the water from the vicinity of the center of the water tank (in Japanese Utility Model Application Publication (Kokoku). No. S53-23982) or from a fan-shaped open part (in Japanese Patent Application Laid-Open (Kokai) No. 10-128033), and the outside air passed through that water is made to detour around the lower edge of such fan-shaped open part or outer cylinder on the outside thereof in the radial direction as it is conducted to the upper space in the water tank.

In the apparatus disclosed in Japanese Utility Model Application Publication (Kokoku) No. 63-12839, which uses a moisture separator that turns at high speed, the moisture separator is driven to turn by a motor shaft of the exhaust pump, so that not only does the structure thereof become complex, but there is also a danger of that becoming a source of the occurrence of noise or vibration.

In the apparatuses shown in Japanese Patent Application Publication (Kokoku) No. 6-104098 and Japanese Patent Application Laid-Open (Kokai) No. 4-92636, the outside air is introduced into the upper space inside the water tank, the upper space being above the water surface, and a swirling flow is formed while this air introduction is being made, and thus water is made whirl by that air flow. Also, in the apparatuses shown in Japanese Patent Nos. 2701132, 2701129, and 2772754, the outside air is discharged into water so as to directly cause the water to make a swirling motion. However, in with these apparatuses, air will bubble up in a foam form from indefinite places on the water surface that is making a swirling motion; as a result, the separation of air and water droplets at the water surface will not be sufficient, and very fine dust that was not captured in the water will enter into the upper space together with air and then be exhausted.

Furthermore, in the apparatuses of Japanese Utility Model Application Publication (Kokoku). No. S53-23982 and Japanese Patent Application Laid-Open (Kokai) No. 10-128033, no swirling flow is made, so that centrifugal force cannot be used. As a result, the problem is that the efficiency of separating dust and water droplets from the air is poor.

### BRIEF SUMMARY OF THE INVENTION

The present invention is made in view of such circumstances as described above.

It is an object of the present invention to provide a wet-type electric cleaning apparatus (vacuum cleaner) which involves no turning moisture separator that makes the structure complex and that causes noise and vibrations.

It is another object of the present invention to provide a wet-type electric cleaning apparatus that not only makes the water flow to be a swirling flow but also makes the air flow inside the upper space of the liquid tank to be a strong swirling flow, thus efficiently removing, using centrifugal force, water droplets and dusts contained in the exhaust air.

The above objects are accomplished by a unique structure for a wet-type electric cleaning apparatus in which outside air that contains dust is inducted into a liquid stored in a substantially cylindrical liquid tank, which is filled with the liquid up to a predetermined liquid surface level, by reducing the pressure inside the upper space of the inside of the liquid tank; and this cleaning apparatus includes:
an intake passage having at one end thereof a discharge port for discharging outside air, which contains dust, into the liquid tank in a form of a swirling flow, from the vicinity of the central bottom inside the liquid tank;
a guide panel provided above the discharge port, the guide panel widening in substantially a disc-shape in the radial direction thereof from the vicinity of the center of the liquid tank, thus forming a ring-shaped gap between the outer peripheral edge thereof and the inner circumferential surface of the liquid tank, and conducting air through the ring-shaped gap in a form of a swirling flow to the upper space in the liquid tank; and
an exhaust passage for exhausting air from the upper space of the liquid tank.

In the present invention, as seen from the above, from the discharge port of the intake passage, the outside air that contains dust is conducted in the swirl direction from the vicinity of the central bottom inside the liquid tank, and the outside air discharged from the discharge port is conducted to the under surface of the guide panel and whirls while being vigorously mixed with the liquid. Accordingly, the mixed flow of the outside air and liquid move in the outer peripheral direction of the guide panel due to centrifugal force, and dust is captured in the liquid during this move of the mixed flow; and further, lighter air flows into the upper space inside the liquid tank, while whirling, through the ring-shaped gap that is between the outer peripheral edge of the guide panel and the inner circumferential surface of the liquid tank.

The position where the air flowing out of the liquid stored into the upper space does not extend over the entire liquid surface but is limited to the gap (ring-shaped gap) between the guide panel and the inner circumferential surface of the liquid tank. As a consequence, a sufficiently strong swirling flow of air is generated in the upper space. For that reason, the heavy components contained in that air, that is, the liquid droplets (water droplets) and very fine dust not captured in the liquid, will, due to centrifugal force, adhere to the inner circumferential surface of the liquid tank and be removed, and the lighter air from which those components have been separated will be exhausted from the exhaust passage that opens in the upper space in the liquid tank. Accordingly, the liquid droplets and very fine dust contained in the exhaust air can be efficiently removed.

In the present invention, it is preferable that the intake passage be bent in the vicinity of the upper center of the liquid tank so as to cause the outside air inducted from one side of an upper part of the liquid tank to descend substantially vertically in the vicinity of the center of the liquid tank, thus conducting the inducted air to below the center of the guide panel. The reason for this structure taken is that since the intake passage is provided in the center inside the liquid tank, it does not impede the swirling flow motion of the mixed flow or the swirling flow motion of the air in the upper space.

Furthermore, in the present invention, the exhaust passage is provided with an exhaust port adjacent to and in the radial direction with respect to the intake passage so that the exhaust port opens in the upper space inside the liquid tank. Thus, the air is exhausted without disturbing the swirling motion of air generated on the outside of the intake passage. It is preferable that an exhaust space of as large a capacity as possible be continuously formed to the exhaust port, so that the swirling motion of the air flowing in from the upper space is not disturbed.

It is preferable in the present invention that at the lower part of the intake passage, a swirling flow channel be provided for allowing the outside air discharged from the discharge port to make a swirling flow, because this structure makes it possible to impart a strong swirl motion to the mixed flow of the outside air and the liquid.

It is also preferable in the present invention that the guide panel is inclined so as to be gradually higher from the discharge port side into a direction of swirling flow of the outside air discharged from the discharge port. The reason for this is that the mixed flow can be conducted from the vicinity of the discharge port to the under surface of the guide panel, while whirling, so that the swirling flow motion can be strengthened while the mixed flow rises along the incline of the under surface of the guide panel (that is, while using the force of floatation).

In the present invention, it is preferable that the radius of the guide panel gradually decrease from the discharge port side into a direction of swirling flow of the outside air discharged from the discharge port. With this structure, the ring-shaped gap formed between the outer peripheral edge of the guide panel and the inner circumferential surface of the liquid tank gradually increases from the discharge port side along the swirling direction of the mixed flow, and thus it is possible to augment and strengthen the whirling of the air flowing into the upper space through the ring-shaped gap.

It is also preferable in the present invention that a baffle(s) for removing liquid droplets from the swirling air flow inside the liquid tank be provided, so that it is located more to the outer peripheral side than the exhaust port. With this baffle(s), the swirling flow of air enters the exhaust port after striking the baffle(s). The baffle can be of a cylindrical shape and extends down from the upper part (exhaust space) of the liquid tank between the exhaust port and the inner circumferential surface of the liquid tank.

Furthermore, it is preferable in the present invention that a dry filter be provided on the liquid tank, so that the exhausting air pass through this filter. The reason for this structure is that should any liquid droplets or very fine dust nevertheless be contained in the exhaust air, they can be removed by this filter. By ways of providing an exhaust pump on the liquid tank so as to cover the dry filter, it is even more difficult for liquid droplets or very fine dust to enter the exhaust pump, and the exhaust pump is well protected.

### BRIEF DESCRIPTION OF THE SEVERAL VIEWS OF THE DRAWINGS

FIG. 1 is an external perspective view of a liquid tank, used in a wet-type electric cleaning apparatus, according to one embodiment of the present invention.

FIG. 2 is a top view thereof.

FIG. 3 shows a cross-section of the liquid tank taken along the lines III-III in FIG. 2.

FIG. 4 shows a cross-section of the liquid tank taken along the lines IV-IV in FIG. 2.

FIG. 5 is a cross-sectional view of the liquid tank taken along the lines V-V in FIG. 4.

FIG. 6 is a cross-sectional view of the liquid tank taken along the lines VI-VI in FIG. 4.

FIG. 7 is a cross-sectional view of the liquid tank taken along the lines VII-VII in FIG. 4.

FIG. 8 is a cross-sectional view of the liquid tank taken along the lines VIII-VIII in FIG. 4.

FIG. 9 is a view of the external of an electric cleaning apparatus in which the liquid tank is used.

### DETAILED DESCRIPTION OF THE INVENTION

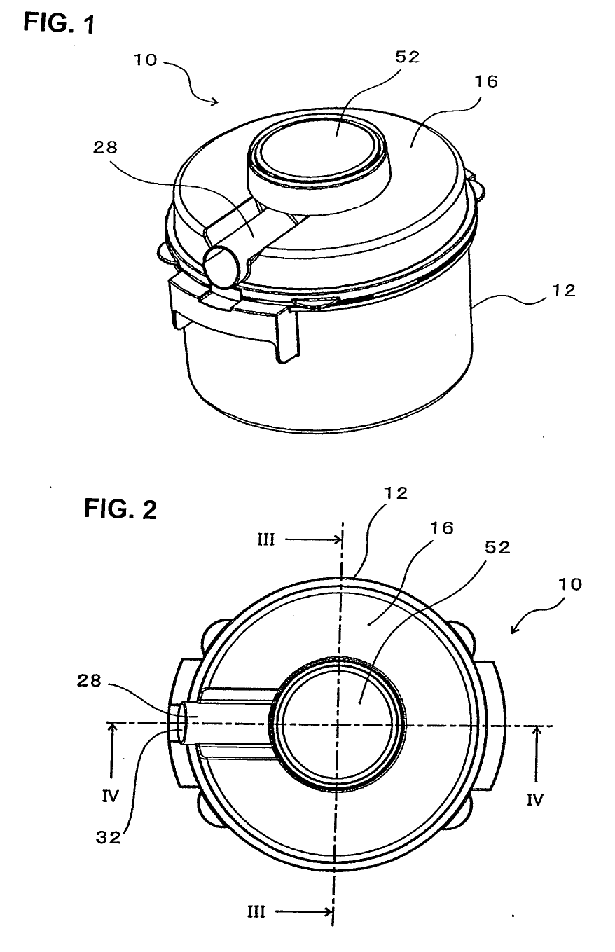

In FIGS. 1 to 4, the reference numeral 10 designates a water tank. The water tank 10 comprises a cylindrical main tank unit 12 having a closed bottom, an inner member 14 mounted at the opening of the main tank unit 12, and a cover 16. The inner member 14 has an upper disk unit 18 that engages the edge of the opening of the main tank unit 12 from above, and the circumferential edge of the upper disk unit 18 is clamped so as to be airtight by packings 20 between the cover 16 and the edge of the opening of the main tank unit 12.

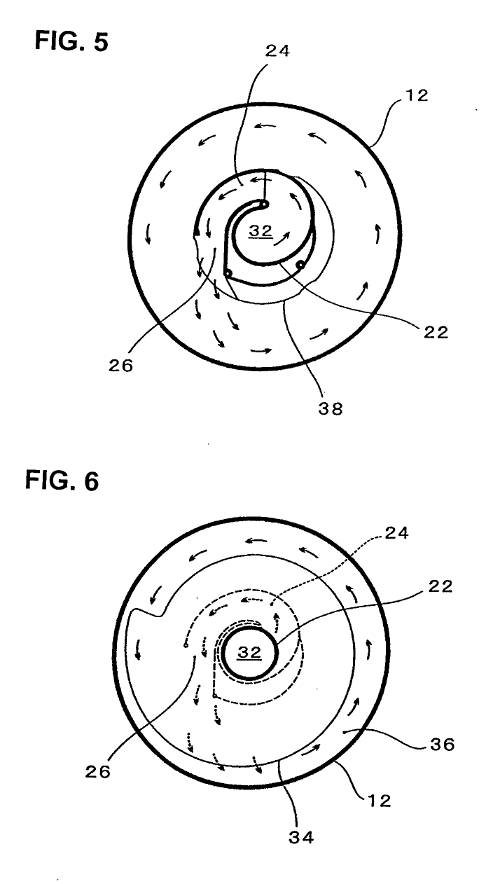

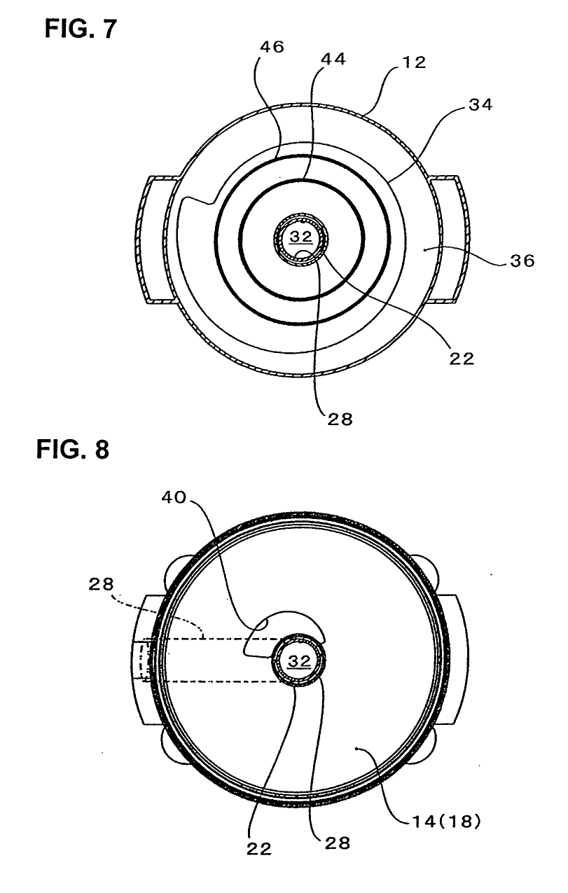

The upper disk unit 18 of the inner member 14 has a circular shape when viewed from above. In the center thereof, a cylindrical part 22 protrudes vertically downward. In the lower end of this cylindrical part 22, as seen from FIG. 5, a swirling flow channel 24 is formed which, while describing a spiral in the horizontal plane, opens toward substantially a tangential direction. The opening of this swirling flow channel 24 at the bottom makes the discharge port 26 of an intake passage 32 that will be described below.

Into the cylindrical part 22, an intake tube 28 is inserted from above. This intake tube 28 is a tube having a circular cross-section, and it is bent at substantially a right angle so that one end of the intake tube 28 extends substantially horizontal toward the direction of the side of a space (exhaust space) 30 between the upper disk unit 18 and the cover 16, and the other end of the intake tube 28 advances inside the cylindrical part 22. Airtightness is maintained between the intake tube 28 and the inner surface of the cylindrical part 22. As a result, with the intake tube 28 and the lower part of the cylindrical part 22, the intake passage 32 (see FIG. 4) is formed that conducts the outside air, which contains dust, to the discharge port 26.

On the upstream end of the intake tube 28, a suction tool (not shown in the drawings) is connected via a flexible connecting tube (not shown), and the outside air that contains dust is conducted from the suction tool and into the main tank unit 12 through the intake passage 32.

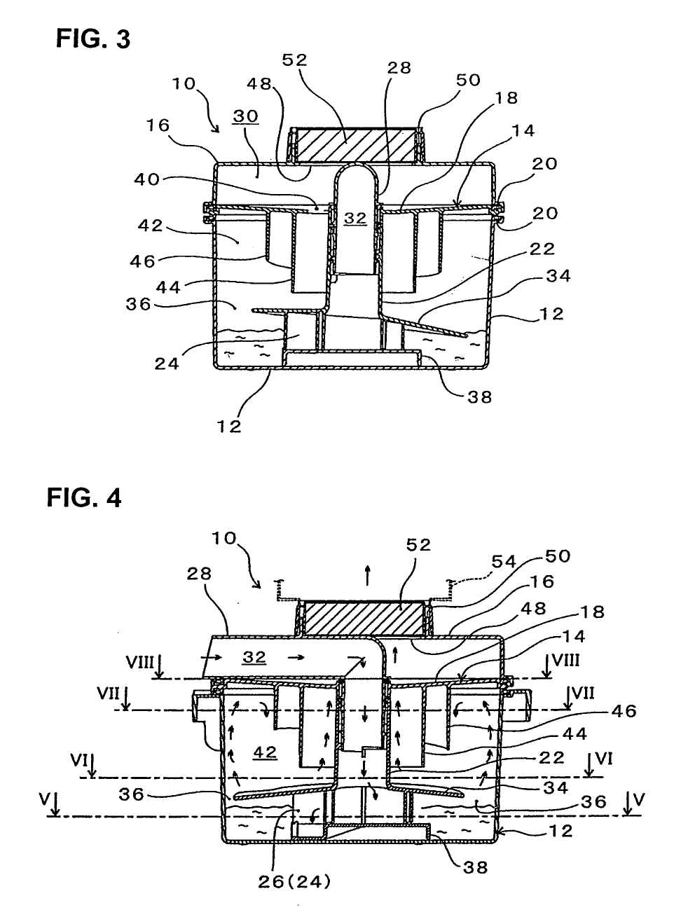

At the lower part of the cylindrical part 22, a guide panel 34 that covers over the discharge port 26 in the shape of a canopy is integrally formed. This guide panel 34 is substantially disc-shaped, and it is inclined as seen from FIG. 4 so that the discharge port 26 side is low and it gradually becomes higher along the direction of opening of the discharge port 26 (or in the direction of the swirling motion of the mixed flow described below). As seen from FIGS. 3 and 4, inside the water tank 10, water is introduced to a height that substantially submerge that guide panel 34 or to a height immediately below the under surface of the guide panel 34.

The guide panel 34, furthermore, forms, as best seen from FIG. 6, a gap (ring-shaped gap) 36 that is ring-shaped when viewed from above, with the outer peripheral edge thereof and the inner circumferential surface of the main tank unit 12. The radius of the guide panel 34, as shown in FIG. 6, is large on the discharge port 26 side, and it becomes gradually smaller along the direction of the opening of the discharge port 26 or in the direction of the swirling motion of the mixed flow (in other words the radius becomes smaller in the counterclockwise direction in FIG. 6). As a result, the ring-shaped gap 36 is narrow on the discharge port 26 side and it becomes gradually larger in conjunction with the turning in the direction of the opening of the discharge port 26 or in the direction of the swirling motion of the mixed flow (in other words the ring-shaped gap 36 becomes larger in the counterclockwise direction in FIG. 6)).

As seen from FIGS. 3 and 4, at the lower end of the cylindrical part 22, a bottom panel 38 is provided. This bottom panel 38 gradually increases the cross-sectional area of the swirling flow channel 24 in the downstream direction by gradually lowering the bottom surface of the swirling flow channel 24 in the direction of the swirling motion of the mixed flow. In other words, the bottom panel 38 is a cylinder with its height gradually decreases in the counterclockwise direction in FIG. 6

As shown in FIG. 3, the upper disk unit 18 of the inner member 14 is formed with an exhaust port 40 adjacent to the outside in the radial direction of the cylindrical part 22. This exhaust port 40 is substantially arc shaped and partially surrounds the cylindrical part 22 as illustrated in FIG. 8, and it connects the upper space 42 inside the water tank 10 to the exhaust space 30 which is between the inner member 14 and the cover 16.

On the under surface of the upper disk unit 18, as seen from FIGS. 3 and 4, two baffle elements or baffles 44 and 46 are formed. The baffles 44 and 46 are in a cylindrical shape and concentric with the cylindrical part 22. The lower edge of the inside baffle panel 44 is horizontal, while the outside baffle panel 46 is smaller in the vertical direction than the inside baffle panel 44, and the lower edge thereof is formed in a spiral shape so as to become, as can be seen by comparing FIGS. 3 and 4, gradually higher along the direction of the swirling motion of the air inside the upper space 42. The above-described exhaust port 40 is located between the cylindrical part 22 and the inside baffle panel 44. In the structure described above, the exhaust port 40 and the exhaust space 30 form an exhaust passage.

At the center of the upper surface of the cover 16, a ring-shaped rib 50 is made to protrude along the edge of the circular opening 48 of the cover 16, and a dry filter 52 is provided in the ring-shaped rib 50. To the rib 50, an exhaust pump 54 (FIG. 4) is attached so as to be in connection with the dry filter 52. The exhaust pump 54, when a fan (not shown) is rotated by an electric motor, exhausts the interior of the exhaust space 30 and the upper space 42 inside the water tank 10 communicating therewith through the exhaust port 40. As a consequence, a negative pressure is generated and maintained in the upper space 42 in the water tank 10, and outside air that contains dust is sucked into the water tank 10 through the intake tube 28 as indicated by arrows in FIG. 4.

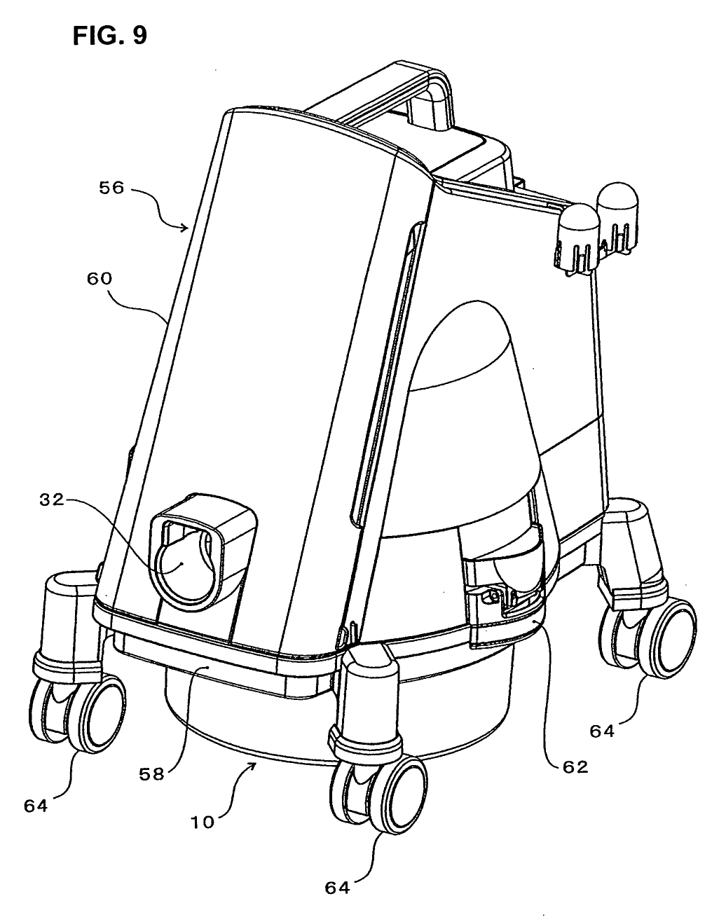

The exhaust pump 54 is housed inside the cleaner body 56 as seen from FIG. 9. The cleaner body 56 has a structure in which a main unit 60 is mounted on a wheeled unit 58 vertically, and they are joined by a pair of left and right locking means 62 (only one is shown). The wheeled unit 58 has casters 64 at the four corners, and the water tank 10 is attached in the center thereof from below. The bottom surface of the water tank 10 is separated from the floor when attached to the wheeled unit 58, and the entirety is made movable by the casters 64.

The exhaust pump 54 is provided inside the main unit 60 as described above; and, when the main unit 60 is mounted on from above on the wheeled unit 58 and the locking means 62 are fastened, a connecting element (not shown) provided in the center of the under surface of the main unit 60 is mated with the rib 50 that surrounds the dry filter 52 on the cover 16 of the water tank 10. In this condition, a suction tool is connected by a flexible connecting tube to the intake passage 32 that opens on the front side of the main unit 60.

Next, the operation of the above-described water tank 10 or the cleaning apparatus will be described below.

When the exhaust pump 54 is activated, outside air that contains dust is conducted through the intake tube 28 to below the cylindrical part 22; and this outside air, while whirling along the swirling flow channel 24, flows, as seen from FIG. 5, from the discharge port 26 into the water inside the water tank 10. This outside air is thus mixed with the water, and the mixed flow whirls in the water, drawing a spiral circle.

When the mixed flow of water and outside air makes swirl motion, since the guide panel 34 covers over the discharge port 26 in the shape of a canopy, the mixed flow is conducted to the under surface of the guide panel 34 and rises, and then it whirls while the swirl motion is being strengthened by that rise. This swirling flow flows out to the outer peripheral side due to centrifugal force, and the outside air and water are vigorously mixed together during, so that the dust contained in the outside air is captured in the water. The outside air brought into rises above the water surface through the ring-shaped gap 36 formed between the outer peripheral edge of the guide panel 34 and the inner circumferential surface of the water tank 10, that is, the inner circumferential surface of the main tank unit 12; and, at that time, the air flow developed from the water surface due to the energy of the swirl motion of the mixture flow will also whirl vigorously.

The above-described air flow would contain droplets that are mixed thereto, and dust that was not captured by the water, such as very fine dust or dust the surface thereof is not readily wetted by water, would be mixed in the air flow. Such water droplets and dust are heavier than air, they will be separated in the outer peripheral direction by the centrifugal force associated with the swirling motion of the air, adhere to the inner surface of the tank and thus be captured. In addition, the swirling air strikes the baffles 46 and 44, and thus water droplets and dust is captured thereby also. Air from which water droplets and dust thus have been removed enters from the exhaust port 40 into the exhaust space 30 while whirling and passes through the dry filter 52, so that it is sucked in by the exhaust pump 54 and exhausted into the atmosphere.

1. A wet-type electric cleaning apparatus for inducting outside air that contains dust into a liquid stored in a substantially cylindrical liquid tank, which is filled with a liquid up to a predetermined liquid surface level, by reducing a pressure inside an upper space of an inside of the liquid tank, said cleaning apparatus comprising:
an intake passage having at one end thereof a discharge port for discharging outside air into the liquid tank in a form of a swirling flow, from the vicinity of a central bottom inside said liquid tank;
a guide panel provided above said discharge port, said guide panel widening in substantially a disc-shape in a radial direction thereof from the vicinity of a center of said liquid tank, thus forming a ring-shaped gap between an outer peripheral edge thereof and an inner circumferential surface of said liquid tank, and conducting air through said ring-shaped gap in a form of a swirling flow to the upper space in said liquid tank; and
an exhaust passage for exhausting air from the upper space in said liquid tank.

2. The wet-type electric cleaning apparatus according to claim 1, wherein said intake passage is bent in the vicinity of an upper center of said liquid tank so as to cause outside air inducted from one side of an upper part of said liquid tank to descend substantially vertically in the vicinity of a center of said liquid tank, thus conducting an inducted air to below a center of said guide panel.

3. The wet-type electric cleaning apparatus according to claim 2, wherein said exhaust passage is provided with an exhaust port adjacent in a radial direction with respect to said intake passage, said exhaust port being opened into the upper space of said liquid tank.

4. The wet-type electric cleaning apparatus according to claim 1, wherein, at a lower part of said intake passage, a swirling flow channel is provided for allowing outside air to flow in a spiral direction from said discharge port.

5. The wet-type electric cleaning apparatus according to claim 4, wherein said guide panel is inclined so as to be gradually higher from a discharge port side into a direction of swirling flow of outside air discharged from said discharge port.

6. The wet-type electric cleaning apparatus according to claim 5, wherein a radius of said guide panel gradually decreases from said discharge port side into a direction of swirling flow of outside air discharged from said discharge port.

7. The wet-type electric cleaning apparatus according to claim 1, further comprising a baffle for removing liquid droplets from a air flow swirling inside said liquid tank, said baffle being provided further outer circumferential side than said exhaust port which is formed in said exhaust passage and opens inside of said liquid tank.

8. The wet-type electric cleaning apparatus according to claim 7, wherein said baffle is in substantially a cylindrical shape and extends from the upper part of said liquid tank.

9. The wet-type electric cleaning apparatus according to claim 1, further comprising a dry filter which is provided on said liquid tank so as to allow an exhaust air to pass therethrough.

10. The wet-type electric cleaning apparatus according to claim 9, wherein an exhaust pump is provided on said liquid tank so as to cover said dry filter.
